(19) United States
(12) Patent Application Publication
(10) Pub. No.: US 2009/0102617 A1
(43) Pub. Date: Apr. 23, 2009

(54) Method, system and computer program product for controlling a plurality of devices in an environment

(76) Inventor: Douglas Thommes, North Pole, AK (US)

Correspondence Address: MAIER & MAIER, PLLC, 1000 DUKE STREET, ALEXANDRIA, VA, 22314, US

(21) Appl. No.: 11/976,148

(22) Filed: Oct. 22, 2007

(51) Int. Cl. G05B 11/01; G06F 3/048

(52) U.S. Cl. 340/310.11; 715/771

(57) ABSTRACT

In accordance with at least one exemplary embodiment, a method, system and computer program product for controlling a plurality of devices in an environment is disclosed. Exemplary embodiments can include a controller connected to a wireless network, such as a WLAN. The controller can have a control panel interface. The control panel interface can be customizable. Control stations can be connected to a wireless network and can convert instructional commands to device-specific control commands. Infrared remote-controlled legacy devices can be associated with the control stations. The legacy devices can be responsive to the device-specific control commands. Electrical outlet devices and electrical switch devices having microcontrollers and wireless receivers can be connected to the wireless network. Electrical outlet device and electrical switch devices can be responsive to state-changing commands.

### BACKGROUND

Electrical outlets providing sockets for plugging in and powering electrical and electronic devices are a mainstay of modern society. For the foreseeable future, many electrical and electronic devices will be dependent on electrical outlets. Related thereto, conventional “light switches” (i.e. electrical switches) allow for manual control of the state of such outlets in and around homes, offices, businesses, etc. Conventional light switches also allow for manual control of the state of lighting fixtures not associated with an electrical outlet, but otherwise powered.

In its simplest form, a “light switch” toggles the state of an electrical outlet or a lighting fixture between “on” and “off”. More advanced “light switches” having dimmers allow for the control of the amount of light produced by lighting fixtures associated therewith. Electrical outlets and switches are useful for providing and denying power to numerous electronic and electrical devices. For example, electrical outlets and switches are also commonly used by people to turn electric fans (e.g., personal and ceiling fans) “on” and “off”.

Infrared remote-controlled electronic devices are ubiquitous. Such legacy devices include conventional television sets, stereo equipment and components, radios, digital clocks, various digital media players/recorders, digital video disc (“DVD”) players, videocassette recorders (“VCRs”), cable boxes and combinations thereof, to name a few. Even home appliances are often equipped with infrared remote-control capabilities. Indeed, the list of infrared remote-controlled legacy devices typically found in a private residence or elsewhere goes on.

An infrared remote control usually offers various commands that can be selected by a user to control various operations of the corresponding electronic device. Besides simply turning a device “on” or “off”, infrared remote controls are often designed to command all of the operations available for a given device. In fact, many electronic devices only allow a user to control a minimal number of operations by operating the device directly whereas most of a device's operations can only be commanded via its corresponding remote control.

While conventional infrared remote controls (and some remote controls making use of radio data signals) have proven to be convenient, they are limited in range and functionality. A particular drawback is that the infrared remote controls for operating corresponding devices are required to do so in a line-of-sight fashion. Conventional universal remotes that can be programmed to control multiple electronic devices have also proven to be convenient as they reduce redundancy, but still suffer from many of the same drawbacks. Nevertheless, consumers are expected to continue making extensive use of infrared remote-controlled legacy devices for the near future as they have been widely accepted by the market and are predicted to only slowly be replaced by next generation technologies, if at all.

Wireless technologies have significantly progressed since the inception of the infrared remote. A variety of wireless communication modes allow for the transmission of data between various electronic devices. For example, technologies making use of wireless communication modes include Radio Frequency Identification (“RFID”), BLUETOOTH® and wireless local area network (“WLAN”) networking. Current and widely-used Wi-Fi and BLUETOOTH® technologies rely on the IEEE 802.11 WLAN and IEEE 802.15.1 wireless personal area network (“PAN”) standards, respectively, as developed by the Institute of Electrical and Electronics Engineers (“IEEE”). Wireless technologies and standards also include ultra-wide band (“UWB”) wireless networking and the WiMax standard (IEEE 802.16), among others.

WLAN and wide area network (“WAN”) access through WLAN is presently widespread and growing more so. Particularly, Wi-Fi (IEEE 802.11) technologies have allowed numerous electronic devices to be wirelessly networked locally while maintaining access to the Internet. As implied above, other technologies with similar and/or overlapping functionalities are expected to be created, developed, commercialized and/or further commercialized as the case may be.

In fact, updated counterparts of many of the legacy devices are on the market or expected shortly that employ Wi-Fi technologies. These devices can be networked and even managed remotely if provided the capability.

Other electronic devices presently employing Wi-Fi networking capability include desktop computers, laptop computers, tablet computers, personal digital assistants, mobile phones, portable media players and any combination thereof, among others. As such, modern Wi-Fi counterparts of the many existing and widely-used legacy devices and other Wi-Fi electronic devices are capable of being networked and thus also managed over a WLAN.

Nevertheless, management of legacy devices over WLANs is also desirable. It would be beneficial if the WLAN management of legacy electronic devices and electrical devices could be accomplished in an efficient and cost-effective manner.

### SUMMARY

According to at least one embodiment, a system for controlling a plurality of devices can include a controller that can be connected to a wireless network. The controller can have a control panel interface. One or more control stations can be connected to a wireless network. Each of the control stations can convert instructional commands to device-specific control commands. One or more legacy devices can be associated with each of the control stations. Each of the legacy devices can be responsive to one or more of the device-specific control commands. One or more electrical outlet devices can be connected to the wireless network. Each of the electrical outlet devices can be responsive to one or more state-changing commands. One or more electrical switch devices can be connected to the wireless network. Each of the electrical switch devices can be responsive to one or more state-changing commands.

In another exemplary embodiment, a method of controlling a plurality of devices in an environment can include providing a control panel interface on a controller. A command can be processes via the control panel interface. A first data signal embodying the command can be transmitted over a wireless network. The command can be received at one of a control station, an electrical outlet device and an electrical switch device. The command can be processed at one of the control station, the electrical outlet device and the electrical switch device.

In yet another exemplary embodiment, a computer program product for controlling a plurality of devices in an environment can include a computer storage medium and a computer program code mechanism embedded in the computer storage medium for causing a computer to manage a plurality of devices. The computer program code mechanism can include a first computer code device that can be configured to provide a control panel interface. The control panel interface can have a plurality of buttons assigned to a plurality of device commands. A second computer code device can be configured to accept a selection from the plurality of buttons. A third computer code device can be configured to match the selection to an assigned device command. A fourth computer code device can be configured to effectuate transmittal of the command to a device via a network. The command can be transmitted by a radio data signal.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is a block diagram of an exemplary computer system.

FIG. 2 schematically depicts an exemplary system for managing a plurality of devices in an environment.

FIG. 3 is a flowchart of an exemplary process for controlling a legacy device with a controller via a control station over a WLAN.

FIG. 4 is a flowchart of an exemplary process for state-changing an electrical outlet device or electrical switch device with a controller over a WLAN.

FIG. 5 is a GUI window showing an exemplary device log for programming/customizing a control panel interface.

FIG. 6 is a GUI window showing an exemplary successor device log of the device log of FIG. 5.

FIG. 7 is a GUI window and associated GUI subentry window showing an exemplary remote control log and an exemplary command log, respectively, for programming/customizing a control panel interface.

FIG. 8 is a GUI window and two associated GUI subentry windows showing an exemplary control station log and two exemplary command logs, respectively, for programming/customizing a control panel interface.

FIG. 9 is a GUI showing an exemplary blank, customizable control panel and customizing buttons.

FIG. 10 is a GUI showing an exemplary customized, customizable control panel.

FIG. 11 is a GUI showing an exemplary button associated with an exemplary button widow that is, in turn, associated with the exemplary device log window of FIG. 6, all for programming/customizing a control panel interface.

FIG. 12 is a GUI showing another exemplary button associated with another exemplary button window that is, in turn, associated with the exemplary device log of FIG. 6, all for programming/customizing a control panel interface.

FIG. 13 is a GUI showing yet another exemplary button associated with yet another exemplary button window, both for programming/customizing a control panel interface.

FIG. 14 is a GUI window having an exemplary macro-command defined therein for programming/customizing a control panel interface.

### DETAILED DESCRIPTION

Aspects of the invention are disclosed in the following description and related drawings directed to specific embodiments of the invention. Alternate embodiments may be deviced without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the invention”, “embodiment” or “invention” do not require that all embodiments of the invention include the discussed feature, advantage or mode of operation.

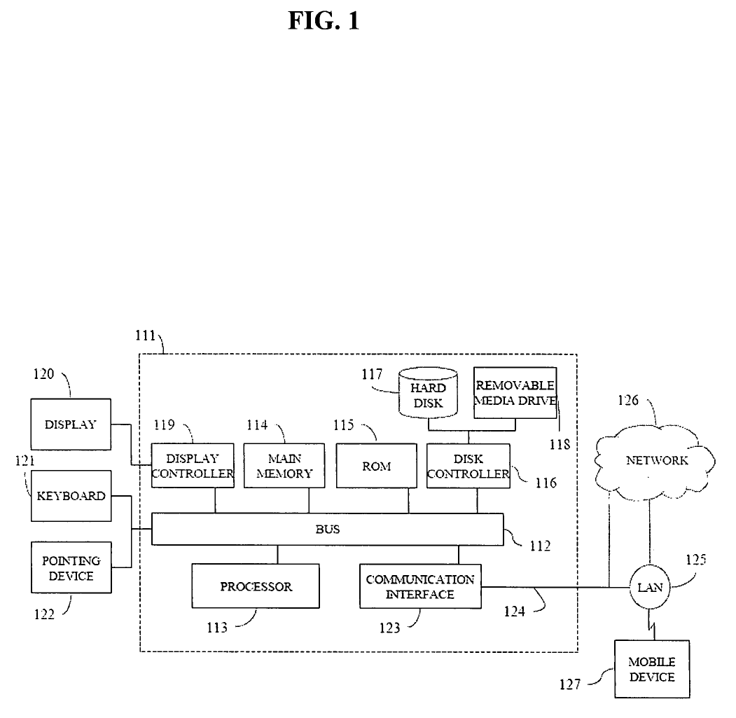

FIG. 1 illustrates a computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system and method known to one having ordinary skill in the art. The databases may be provided, for example, as a database management system (DBMS), a relational database management system (e.g., DB2, ACCESS, etc.), an object-oriented database management system (ODBMS), a file system or another conventional database package as a few non-limiting examples. The databases can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer user. The computer system may include input devices, such as a keyboard 121 and a pointing device 122, for interacting with a computer user and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on any combination of computer readable media, the present invention includes software for controlling the computer system 111, for driving a device or devices for implementing the invention, and for enabling the computer system 111 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., a LAN) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

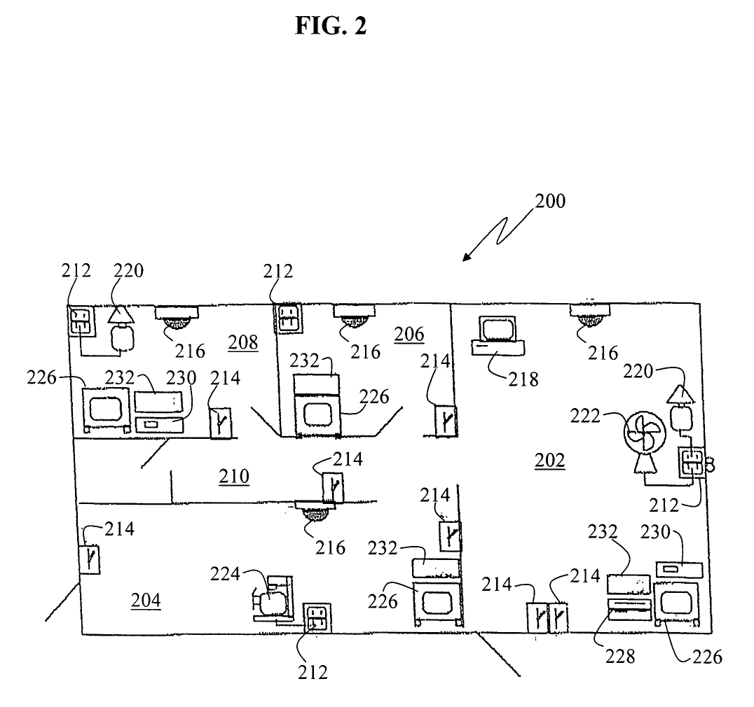

Referring to FIG. 2, an exemplary system for managing a plurality of devices in an environment is schematically depicted in accordance with at least one exemplary embodiment. Solely for illustrative purposes and in a non-limiting manner, FIG. 2 depicts an exemplary environment with exemplary electronic and electrical devices that can be managed by at least one exemplary embodiment. Those having ordinary skill in the art will recognize that embodiments can be used in numerous and varied environment, as well as with numerous and varied devices. For example, as shown, environment 200 can be a residential environment. Nevertheless, exemplary embodiments can be used to manage a variety of devices in nonresidential environments, such as businesses, offices and the like.

Exemplary environment 200 can include living area 202, food preparation area 204, first bedroom area 206, second bedroom area 208 and hallway 210. Throughout environment 200 there can be electrical outlet devices 212, electrical switch devices 214 and control stations 216. Controller 218 can be wirelessly networked with electrical outlet devices 212, electrical light switch devices 214 and control stations 216 for controlling each. Electrical outlet devices 212, electrical switch devices 214 and control stations 216 may require relatively little work to install within exemplary environment 200. For example, renovation of existing structures may not be required.

Electrical outlet devices 212 can have a variety of electrical and electronic devices respectively associated therewith. As shown, electrical outlet devices 212 can be associated with electrical devices, such as lamps 220, personal fan 222 and coffee maker 224.

Electrical light switch devices 214 can be associated with lighting fixtures (not shown) throughout environment 200 for respectively controlling the provision of light to living area 202, food preparation area 204, first bedroom area 206, second bedroom area 208 and hallway 210, as well as to a main porch (not shown) and a back porch (not shown).

Control stations 218 can be respectively situated in each of living area 202, food preparation area 204, first bedroom area 206 and second bedroom area 208. Under infrared remote-control of control station 218 can be a variety of legacy electronic devices, including televisions 226, stereo equipment 228, DVD players 230, cable boxes 232 and like legacy devices.

Controller 218 can be a computer system consistent with computer system 111 of FIG. 1, which can have access (locally or remotely) to a computer program product for managing a plurality of devices. The computer program product can cause controller 218 to display a control panel interface (described below) that can be operated by a human. The control panel interface may be displayed on a touch screen display in at least one exemplary embodiment. Controller 218 can be connected to a wireless network, such as a Wi-Fi local area network for communicating with electrical outlet devices 212, electrical switch devices 214 and control stations 216.

Controller 218 can be a desktop computer, a laptop computer, a tablet computer and the like. Moreover, controller 218 can be a personal digital assistant, a mobile phone, a portable media player, any combination thereof, and the like known to one having ordinary skill in the art. Further, controller 218 can also be a more specialized computer system. For example, controller 218 can be designed to act primarily (or even solely) as a controller and can be provided in a hand-held unit, a tabletop unit, a wall-mounted unit and the like. Also, more than one controller 218 can be used to manage devices in environment 200.

For example, subcontrollers can be provided in addition to main controller 218. In at least one exemplary embodiment, subcontrollers can be specialized hand-held units, tabletop units, wall-mounted units and the like. Controller 218 may be a personal computer. Also, in at least one exemplary embodiment, subcontrollers can employ a touch screen for accepting human inputs. Subcontrollers may also be wired or wirelessly connected to controller 218 for downloading processor-executable instructions and data for providing a control panel interface and any other needed or optional functionality. The control panel interface may be separately customizable on each subcontroller. Also, different control panel interfaces may be stored on a single controller under more than one user, so as to provide different human operators with different interfaces in line with their preferences.

Electrical outlet devices 212 can have one or more sockets for plugging in and powering electronic and electrical devices. Electrical outlet devices 212 can resemble conventional electrical outlets in that, for example, each electrical outlet device can provide one or more sockets, but can also have a wireless network receiver and a microprocessor coupled therewith. Electric outlets devices 212 can be integrated devices or can be the combination of retrofitable devices adapted to conventional electrical outlets.

In at least one exemplary embodiment, electrical outlet devices 212 can include a microcontroller for processing and storing data, among other functions. In another exemplary embodiment, electrical outlet devices 212 can include a wireless transceiver for both receiving and transmitting data signals. Such electrical outlet devices 212 can broadcast the status of their state (e.g., “on” or “off”) over a wireless network.

Electrical outlet devices 212 can receive commands via wireless data signals and can process such commands to effectuate a state-change of either providing or denying power at each electrical outlet device 212. In at least one exemplary embodiment, the state of each socket of electrical outlet devices 212 can be separately controlled and managed. Control of electrical outlet device 212 can be used to manage the state of lamps 220, personal fan 222 and coffee maker 224, respectively, at each electrical outlet device 212 (and each socket thereof). In this respect, electrical outlet devices 212 can have switch functionality, which can be remotely managed by controller 218 over a WLAN, such as a Wi-Fi local area network.

Electrical switch devices 214 can be associated with lighting fixtures for controlling the state of the lighting fixtures. Electrical switch devices 214 can be any of a variety of designs, as will be recognized by one having ordinary skill in the art. For example, electrical switch devices 214 can resemble any commercially available design. In at least one exemplary embodiment, electrical switch devices 214 can have dimmer functionality. Furthermore, in at least one exemplary embodiment, electrical switch devices 214 may each include a touch screen display for displaying and accepting commands selected by a human operator at each electrical switch device 214. Electrical switch devices 214 having touch screen displays may be designed to occupy the same conventional wall boxes that various conventional electrical switches are designed to occupy.

Electrical switch devices 214 can have a wireless network receiver and a microprocessor coupled therewith. In at least one exemplary embodiment, electrical switch devices 214 can include a microcontroller for processing and storing data, among other functions. In yet another exemplary embodiment, electrical switch devices 214 can include a wireless transceiver for both receiving and transmitting data signals over a wireless network. Such electrical switch devices 212 can broadcast the status of their state (e.g., “on”, “off”, “low light”, “medium light” and “bright light”) over a wireless network.

Electrical switch devices 214 can receive commands via data signals over a WLAN, such as a Wi-Fi local area network. Electrical switch devices 214 can process such commands to effectuate a state-change of either providing or denying power at lighting fixtures associated therewith. In at least one exemplary embodiment, electrical switch devices 214 can also receive commands to cause lighting fixtures to provision a certain amount of light. In this respect, electrical switch devices 214 can have dimmer functionality. Furthermore, electric switch devices 214 can also allow for manual control as they can resemble conventional electrical switches in construction.

Control stations 216 can be converters for receiving instructional commands from controller 218, converting the instructional commands to legacy device-specific commands and transmitting the legacy device-specific commands. In at least one exemplary embodiment, control stations 216 can be radiofrequency-to-infrared converters. Control stations 216 can include a wireless network transceiver and an infrared transmitter. Control stations 216 can be connected to a WLAN, such as Wi-Fi local area network and can communicate with controller 218. Control station 216 can also include a microprocessor and one or more computer storage mediums.

Each control station 216 can be associated with legacy devices in range. For example, control station 216 can be associated with legacy devices 226, 228, 230, 232 occupying the same room as each control station 216. Control station 216 can be placed or mounted in a room in various locations including on the walls, on the ceiling or on furniture pieces, as a few non-limiting examples.

In at least one exemplary embodiment, control stations 216 can have a dome design, which can allow for multidirectional infrared data signal transmission. Multidirectional infrared data signal transmission may allow each of control stations 216 to respectively control legacy devices 226, 228, 230 associated therewith, where legacy devices 226, 228, 230 can be located in differing three-dimensional spatial relationships with their respective control station 216. Thus, each of control stations 216 may be able to control all associated legacy devices 226, 228, 230 within, for example, a room.

Control stations 216 can be programmable by a human operator, preprogrammed or any combination thereof so as to transmit device-specific commands embodied in infrared data signals to one or more legacy devices, such as televisions 226, stereo equipment 228, DVD players 230 and cable boxes 232. Control stations 216 can be preprogrammed with manufacturer-specific command codes for operating legacy devices. Alternatively, singularly or conjunction, control stations 216 can have learning functionality and can thus be programmable by a human operator. Programmable control stations 216 can “learn” by receiving and storing manufacturer-specific command codes from, for example, device-specific infrared remotes. Such programmable control stations 216 can include an infrared receiver for receiving the manufacturer-specific command codes from device-specific infrared remotes.

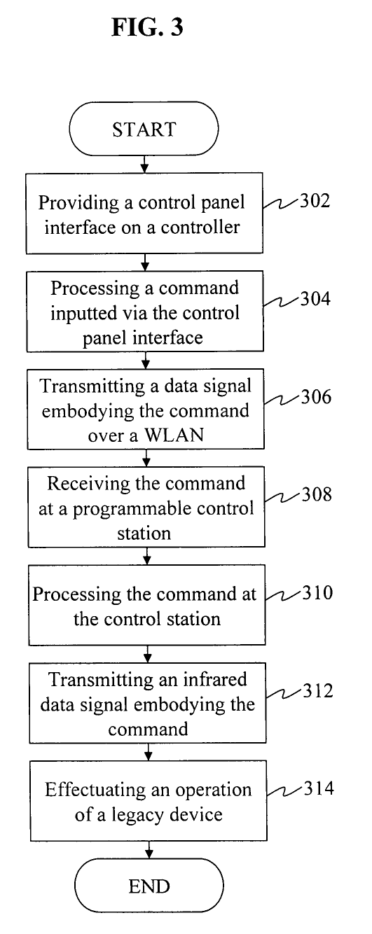

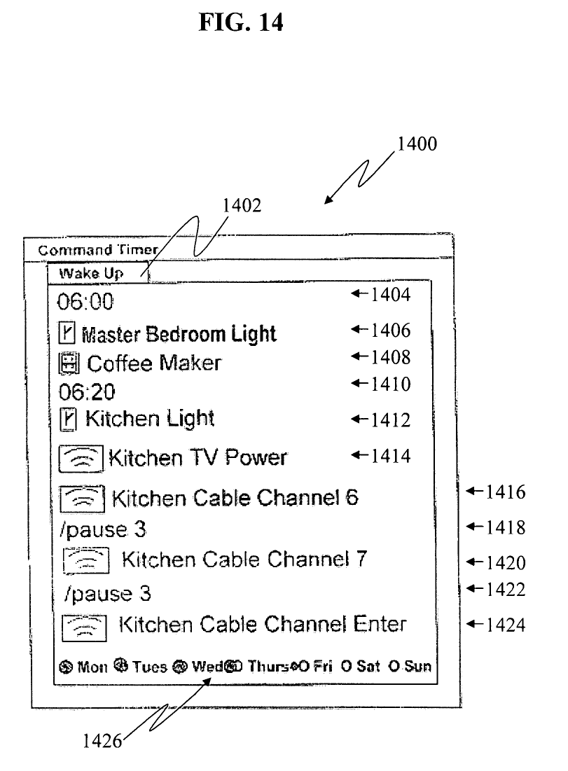

Referring to FIG. 3, a process of controlling legacy devices via a controller is shown in accordance with at least one exemplary embodiment. At step 302, a control panel interface can be provided on the controller. In at least one exemplary embodiment, a control panel (described below) can provide various buttons organized by one or more tabs. Some of the various buttons can be assigned to a single command or a macro-command (i.e. an ordered combination of single commands) for performing an operation or operations, respectively, at predetermined infrared remote-controlled legacy devices. In at least one exemplary embodiment, macro-commands can also include state-changing commands directed to electrical outlet devices and/or electrical switch devices (see, e.g., FIG. 14, described below).

A human operator can select a command for a predetermined legacy device by selecting the appropriate button. At step 304, the controller can process the inputted selection. For example, the controller can accept the selection of the button and can match the button selected to the assigned command at step 304. At step 304, the controller can also effectuate (i.e. perform necessary processes so as to direct) the transmittal of the command over a WLAN, such as a Wi-Fi local area network. The command can be considered instructional as it is not intended to directly control an operation of the predetermined legacy device.

At step 306, the command can be embodied in a data signal and transmitted by a wireless transceiver of the controller. At step 308, the data signal embodying the command can be received by a control station. The control station can be associated with one or more infrared remote-controlled legacy devices.

At step 310, the control station can process the command. Processing the command can include converting the instructional command to a device-specific command intended to command an operation of one of the infrared remote-controlled legacy devices associated with the control station. Processing the command can also include effectuating (i.e. performing necessary processes so as to direct) transmittal of the device-specific command. At step 312, an infrared transmitter of the control station can transmit an infrared data signal embodying the device-specific command.

At step 314, an operation of a predetermined legacy device can be effectuated (i.e. brought about). As is known to one having ordinary skill in the art, the predetermined legacy device can receive the infrared data signal embodying the command. In turn, the receiver can convert the data signal into a device-readable command. The command can then be passed to a microprocessor of the legacy device where the command can be processed so as to effectuate an operation of the legacy device.

Operations can include those for controlling the state (i.e. “on” or “off”), the functions, the channel/station, the volume and the settings of the legacy device, as well as any other operations known to one having ordinary skill in the art. The process of FIG. 3 can be repeatable and can be carried out separately for controlling operations of each legacy device associated with the control station. Also, each step of FIG. 3 may be independently repeated as necessary to respond to, for example, a macro-command.

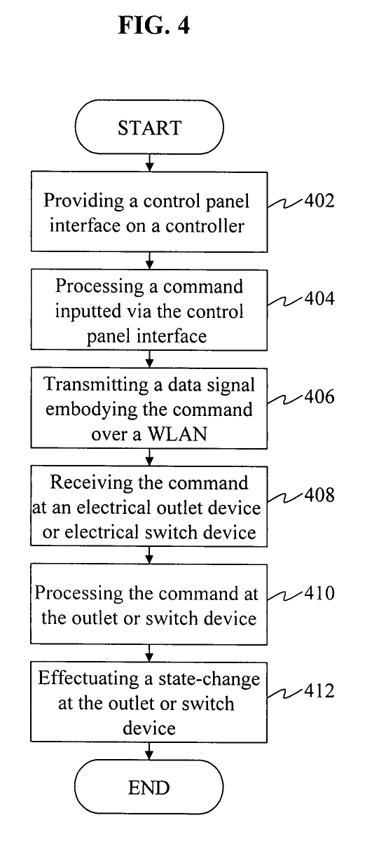

Referring to FIG. 4, a process of controlling the state of an electrical outlet device or an electric switch device via a controller is shown in accordance with at least one exemplary embodiment. At step 402, a control panel interface can be provided on a controller. Similar to the process of FIG. 3, in at least one exemplary embodiment, the control panel can provide various buttons organized by one or more tabs. Some of the various buttons can be assigned to state-changing commands for one or more electrical outlets devices and/or for one or more electrical switch devices.

Also, macro-commands for selecting state changes to one or more electrical outlets and one or more electrical switch devices can be provided on the control panel. Macro-commands can also include commands for controlling one or more infrared remote-controlled legacy devices (see, e.g., FIG. 14, described below).

A human operator can select a state-changing command for a predetermined electrical outlet device or predetermined electrical switch device by selecting the appropriate button. At step 404, the controller can process the inputted selection. For example, the controller can accept the selection of the button and can match the button selected to the assigned state-changing command at step 404. At step 404, the controller can also effectuate (i.e. perform necessary processes so as to direct) the transmittal of the state-changing command over a WLAN, such as a Wi-Fi local area network.

At step 406, the state-changing command can be embodied in a data signal and transmitted by a wireless transceiver of the controller. At step 408, the data signal embodying the state-changing command can be received by the electrical outlet device or the electrical switch device. More particularly, the data signal can be received at a wireless receiver/transceiver of the electrical outlet device or electrical switch device.

At step 410, the electrical outlet device or the electrical switch device can process the state-changing command (e.g., via a microcontroller coupled thereto). Processing the command can direct a state-change at the electrical outlet device or the electrical switch device. If so processed, a state-change can be effectuated at the electrical outlet device or the electrical switch device.

With the electrical outlet device acting as an intermediary between the controller and any electrical or electronic device plugged into a socket of the outlet device, a controller can control the state of an electrical or electronic device by controlling the state of the outlet (or each socket thereof). Similarly, a controller can control that state of a lighting fixture by controlling the state of an electrical switch device associated therewith. In at least one further exemplary embodiment, the controller can control an electrical switch device having dimmer functionality for controlling the amount of light provisioned by a lighting fixture.

Similar to the process of FIG. 3, the process of FIG. 4 can be repeatable and can be carried out separately for controlling the state of each electrical outlet device and/or electrical switch device on a WLAN, such as a Wi-Fi local area network. Also, each step of FIG. 4 may be independently repeated as necessary to respond to, for example, a macro-command.

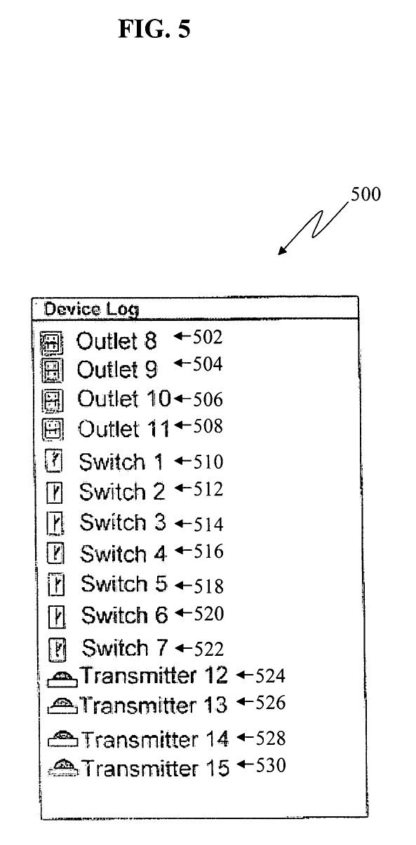

Generally referring to FIGS. 5-14, aspects of exemplary graphical user interfaces (“GUI” or “GUIs”) for customizing/programming an exemplary control panel interface of an exemplary controller are shown in accordance with at least one exemplary embodiment. Solely for illustrative purposes and in a non-limiting manner, FIGS. 5-14 reference exemplary environment 200 of FIG. 2 as a basis to highlight aspects of customizing/programming an exemplary control panel interface.

As such, the aspects shown in FIGS. 5-14 are directed to an exemplary control panel interface for managing the plurality of devices found in environment 200. Moreover, the aspects shown in FIGS. 5-14 illustrate exemplary functionality of an exemplary computer program product executable by an exemplary controller also in accordance with at least one exemplary embodiment.

Referring once again to FIG. 2, electrical outlet devices 212, electrical switch devices 214 and control stations 216 can be installed within environment 200. A WLAN, such as a Wi-Fi local area network, can be available throughout environment 200. Controller 218 can be connected to the WLAN.

In at least one exemplary embodiment, controller 218 can process and display information from the electrical outlet devices 212, electric switch devices 214 and control stations 216. For example, electrical outlet devices 212 can broadcast the state (e.g., “on” or “off”) of each socket so as to be displayed by controller 218. Likewise, electrical switch devices 214 can broadcast the state of the lighting fixtures associated therewith so as to be displayed by controller 218. Control stations 216 can communicate with controller 218 over the WLAN in regard to the state and current operations of the legacy devices respectively associated therewith. Such information can allow a human operator to manage various electronic and electrical devices under the control, whether directly or indirectly, of controller 218.

To establish a wireless management network, electrical outlet devices 212, electrical switch devices 214 and control stations 216 can transmit identifying data signals in a format mode. Controller 218 can search for data signals in format mode so as to identify electrical outlet devices 212, electrical switch devices 214 and control stations 216. Controller 218 can record unique serial numbers (or any other suitable unique identifier) of electrical outlet devices 212, electrical switch devices 214 and control stations 216 into a device log of a computer program product, for example, stored on controller 218 or in a storage device associated therewith.

Unique identifiers can allow controller 218 to separately track the location of each of electrical outlet devices 212, electrical switch devices 214 and/or control stations 216 during formatting (e.g., via an installation application executed thereon) and afterwards. Using unique identifiers in this manner may make trial-and-error processes unnecessary for separately identifying each of electrical outlet devices, 212, electrical switch devices 214 and/or control stations 216 during formatting. The unique serial number can be a network address or any like addresses (whether logical or physical) known to one having ordinary skill in the art. As a result, electrical outlet devices 212, electrical switch devices 214 and control stations 216 can be connected to (and formatted on) the WLAN.

Now referring to FIG. 5, an exemplary device log window of controller 218 is shown. Exemplary device log window 500 can include exemplary entries 502-530 corresponding to each of electrical outlet devices 212, electrical switch devices 214 and control stations 216 of environment 200. Device log window 500 can identify each of electrical devices 212, electrical switch devices 214 and control stations 216 by type (e.g., “Outlet”, “Switch” and “Transmitter”) and by unique identifiers. For illustrative purposes, unique serial numbers (unique identifiers) were simply illustrated as numbers 1-15. In practice, unique serial numbers are likely to be significantly more complex as will be recognized by one having ordinary skill in the art. Device log 500 can also include icons, for example, corresponding to the type of device in each entry.

Entries 502, 504, 506, 508 can correspond to electrical outlet devices 212 of living area 202, food preparation area 204, first bedroom area 206 and second bedroom area 208, respectively. Entries 510, 512, 514, 516, 518, 520, 522 can correspond to electrical switch devices 214 respectively associated with lighting fixtures for provisioning light to a main porch (not shown), living area 202, food preparation area 204, hallway 210, first bedroom area 206, second bedroom area 208 and a back porch (not shown), respectively. Entries 524, 526, 528, 530 can correspond to control stations 216 of living area 202, first bedroom area 206, second bedroom area 208 and food preparation area 204, respectively.

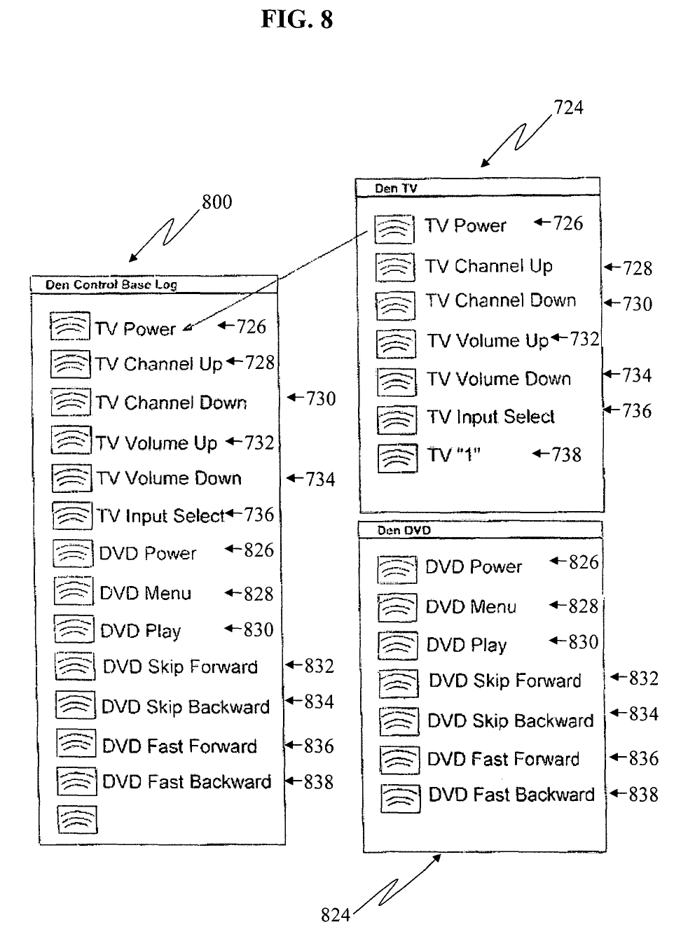

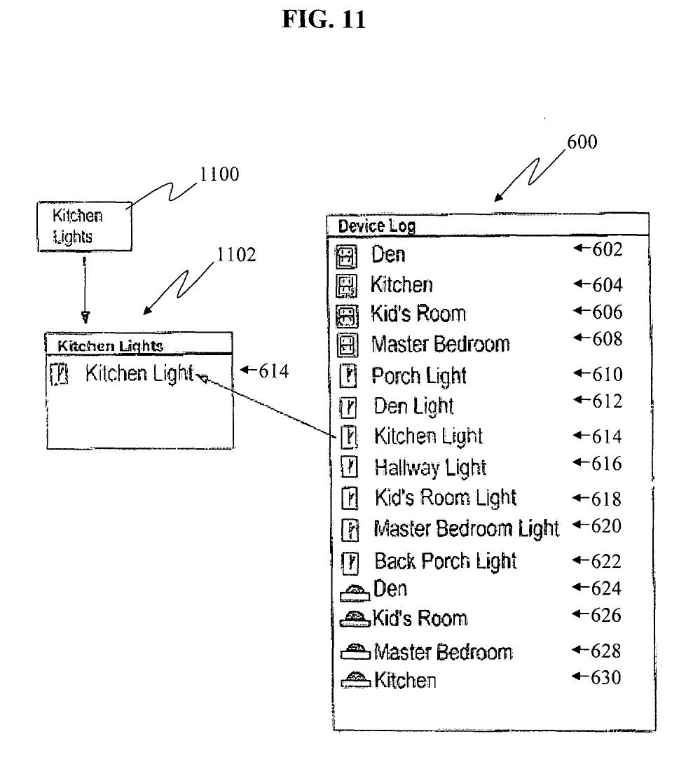

Entries 502-522 corresponding to electrical outlet devices 212 and electrical switch devices 214 can also represent state-changing commands for controlling state-change of each of electrical outlet devices 212 and electrical switch devices 214. Commands 502-522 can be assigned to buttons on an exemplary control panel interface (see FIGS. 11-14, described below). Entries 524, 526, 528, 530 can be selected by a human user and control station log windows (i.e. type of subentry window) can be provided for defining the available commands for each of entries 524, 526, 528, 530 corresponding to control stations 216 (see FIG. 8., described below).

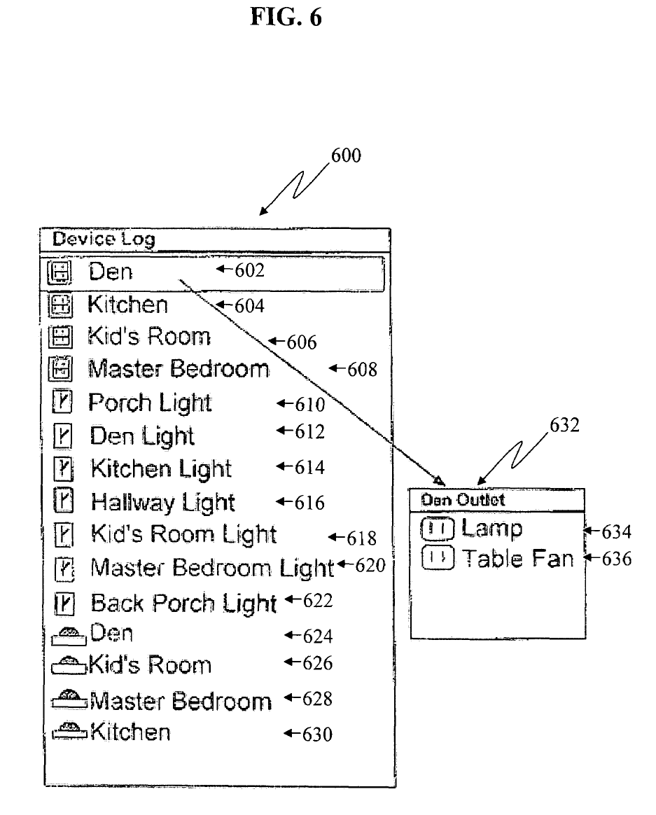

Referring to FIG. 6, exemplary entries 502-530 of exemplary device log window 500 can be renamed by a human operator as exemplary entries 602-630 of exemplary device log window 600. Entries 502-530 can be assigned labels by a human operator so as to, for example, intuitively (e.g., by location controlled within and around environment 200) refer to each of the electrical outlet devices 212, electrical switch devices 214 and control stations 216. Appropriate icons can differentiate electrical outlet devices 212, electrical switch devices 214 and control stations 216.

As shown, entries 602-630 can be labeled “Den” entry 602, “Kitchen” entry 604, “Kid's Room” entry 606, “Master Bedroom” entry 608, “Porch Light” entry 610, “Den Light” entry 612, “Kitchen Light” entry 614, “Hallway Light” entry 616, “Kid's Room Light” entry 618, “Master Bedroom Light” entry 620, “Back Porch Light” entry 622, “Den” entry 624, “Kid's Room” entry 626, “Master Bedroom” entry 628 and “Kitchen” entry 630, respectively.

Subentry windows can be provided in response to a human operator selecting any of entries 602-630 of device log window 600. As shown, exemplary subentry window 632 can be provided in response to selecting “Den” entry 602. Subentry window 632 can have “Lamp” entry 634 and “Table Fan” entry 636 entered by a human operator for representing that lamp 220 and fan 222 may each be plugged into a socket of electrical outlet device 212 of living area 202. Thus, subentry window 632 can define that lamp 220 and fan 222 are each plugged into outlet device 212 of living area 202. The state of each socket of electrical outlet device 212 of living area 202 can mirror the state of lamp 220 and fan 222 defined as associated therewith.

Since entries 602-630 can be the same entries, only renamed, as entries 502-530 of FIG. 5, entries 602-622 corresponding to electrical outlet devices 212 and electrical switch devices 214 can also represent state-changing commands for controlling state-change of each of electrical outlet devices 212 and electrical switch devices 214. Commands 602-622 can be assigned to buttons on an exemplary control panel interface (see FIGS. 11-14, described below). Likewise, entries 624, 626, 628, 630 can be selected by a human user and control station log windows (i.e. type of subentry window) can be provided for defining the available commands for each of entries 624, 626, 628, 630 corresponding to control stations 216 (see FIG. 8., described below).

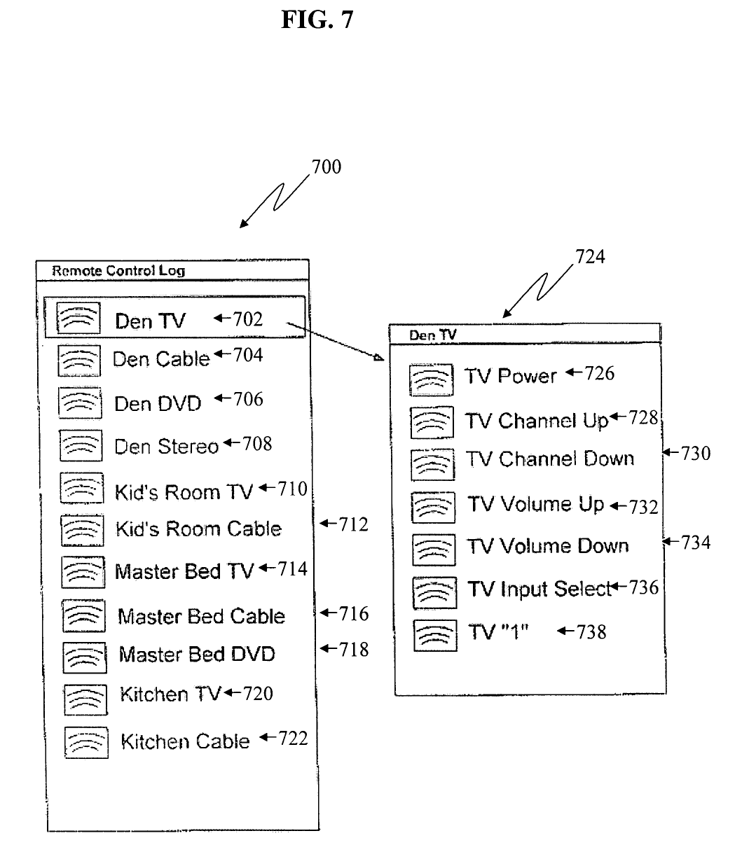

Referring to FIG. 7, an exemplary remote control log window of controller 218 is shown. As previously stated, control stations 216 can be programmable by a human operator, preprogrammed or any combination thereof so as to transmit device-specific commands embodied in infrared data signals to one or more legacy devices, such as televisions 226, stereo equipment 228, DVD players 230 and cable boxes 232.

Command data can be transmitted from each of control stations 216 to controller 218. Controller 218 can store or otherwise access commands for infrared remote-controlled legacy devices associated with control stations 216.

Exemplary remote control log window 700 can include exemplary entries 702-722 corresponding to legacy devices 226, 228, 230, 232 respectively associated with control stations 216. In at least one exemplary embodiment, control stations 216 can have learning functionality. Remote control log window 700 of controller 218 can have entries 702-722 corresponding to all infrared remote controls from which control stations 216 learned device-specific commands from.

As shown, entries 702-722 can be labeled by a human operator to, for example, intuitively refer to each of legacy device 226, 228, 230, 232 as respectively associated with each of control stations 216. “Den TV” entry 702, “Den Cable” entry 704, “Den DVD” entry 706, and “Den Stereo” entry 708 can correspond to television 226, cable box 232, DVD player 230 and stereo equipment 228, respectively, under the control of control station 216 of living area 202. “Kid's Room TV” entry 710 and “Kid's Room Cable” entry 712 can correspond to television 226 and cable box 232, respectively, under the control of control station 216 of first bedroom area 206. “Master Bed TV” entry 714, “Master Bed Cable” entry 716 and “Master Bed DVD” entry 718 can correspond to television 226, cable box 232 and DVD player 230, respectively, under the control of control station 216 of second bedroom area 208. “Kitchen TV” entry 720 and “Kitchen Cable” entry 722 can correspond to television 226 and cable box 232, respectively, under the control of control station 216 of food preparation area 204.

Subentry windows can be selected by a human operator and can list all of the stored commands for each infrared remote-controlled legacy device 226, 228, 230, 232 stored on control stations 216 and controller 218. For example, once selected, exemplary subentry window 724 can include entries 726-738 (i.e. “TV Power” entry 726, “TV Channel Up” entry 728, “TV Channel Down” entry 730, “TV Volume Up” entry 732, “TV Volume Down” entry 734, “TV Input Select” entry 738 and “TV ‘1’” entry 738) that can correspond to commands for operating television 226 of living area 202.

Referring to FIG. 8, an exemplary control station log window of controller 218 is shown. Control station log windows can be used to assign the proper commands to the proper control station 216 of each of living area 202, food preparation area 204, first bedroom area 206 and second bedroom area 208. As such, controller 218 can process instructional commands so as to be designated for the proper control station 216. Control station log windows can also be used to assign Instructional commands to buttons on a control panel interface of controller 218.

Exemplary den control log window 800 can be configured to have exemplary entries corresponding to all or part of the commands for legacy devices 226, 228, 230, 232 controllable by control station 216 of living area 202. Den control log window 800 can be provided in response to a user selecting (e.g., by a right-clicking action with a pointing device, by a touch action on a touch screen, etc.) “Den” entry 624 on exemplary device log 600 of FIG. 6. As such, commands for legacy devices 226, 228, 230, 232 controllable by control station 216 of living area 202 can be associated with “Den” entry 624 so that a user may select “Den” entry 624 as a whole or any commands provided thereunder for assigning buttons on a control panel interface to one or more commands (see FIGS. 11-14, described below).

Exemplary entries 726-738 of subentry window 724 can be selected (individually or together) and placed (e.g., by drag-and-drop actions with a pointing device, by touching actions on a touch screen, etc.) into den control log window 800 for controlling operations of television 226 of living area 202. Also, another exemplary subentry window 824 having exemplary entries 826-838 (i.e. “DVD Power” entry 826, “DVD Menu” entry 828, “DVD Play” entry 830, “DVD Skip Forward” entry 832, “DVD Skip Backward” entry 834, “DVD Fast Forward” entry 836 and “DVD Fast Backward” entry 838) that can correspond to commands for operating DVD player 230 of living area 202, can be selected and placed into den control log window 800 for controlling operations of DVD player 230 of living area 202 through control station 216 of living area 202 by controller 218.

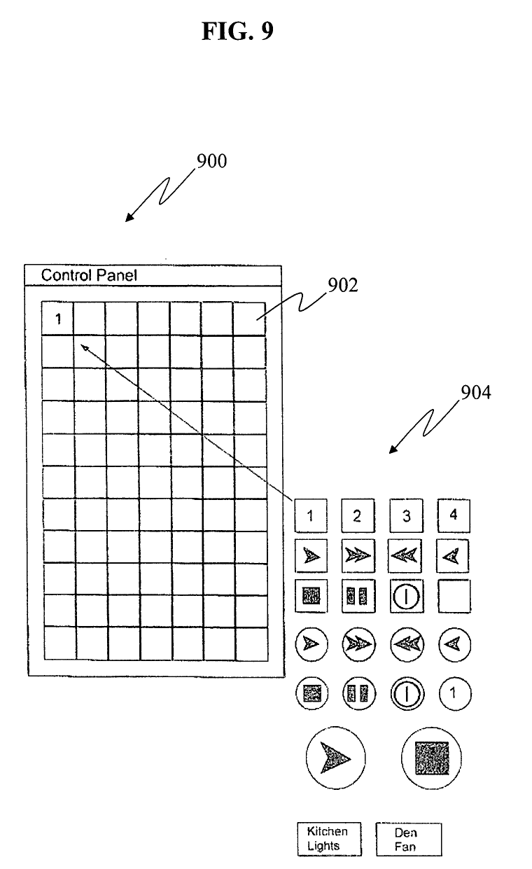

Referring to FIG. 9, an exemplary blank, customizable control panel interface of controller 218 is shown. Exemplary control panel interface 900 can include substantially unfilled grid 902. A human operator of control panel interface 900 can be provided various buttons 904 for customizing grid 902 as an aspect of a GUI of controller 218. Buttons 904 can be selected, placed and arranged (e.g., by drag-and-drop actions with a pointing device, by touching actions on a touch screen, etc.) onto customizing grid 902.

Buttons 904 can be provided in a variety of shapes and sizes. Buttons 904 can resemble conventional buttons on legacy devices, such as televisions 226, stereo equipment 228, DVD players 230 and cable boxes 232. Moreover, buttons 904 can themselves be customizable by shape and indicia. For example, a human operator can label some buttons 904 with text, for example, in order to designate function.

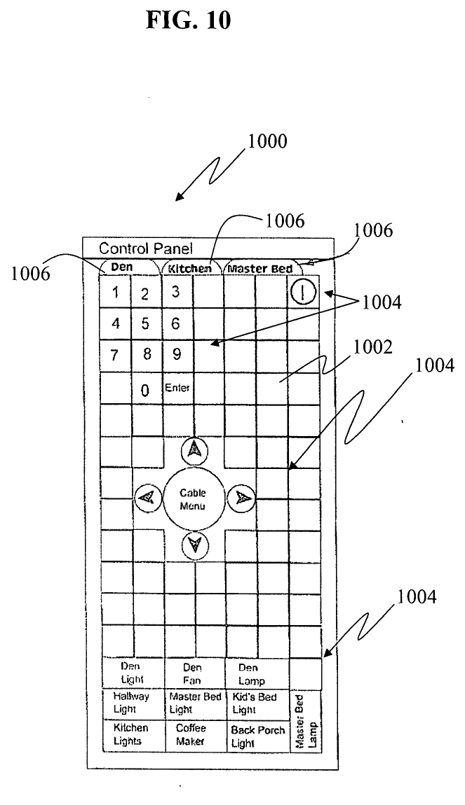

Referring to FIG. 10, an exemplary customized control patent interface of controller 218 is shown. Exemplary control panel interface 1000 can include partially-filled grid 1002. Various buttons 1004 can be organized on grid 1002. Also, control panel interface 1000 can include tabs 1006 and like navigational widgets for providing two or more alternative control panel faces for selecting commands to electronic and electrical devices. Tabs 1006 can be employed to allow a human operator to separate buttons 1004 (and associated commands) by device, location, relative use and the like. As shown, tabs 1006 can be used to separate buttons 1004 by living area 202, food preparation area 204 and second bedroom area 208.

In FIG. 11, exemplary button 1100 (labeled “Kitchen Lights”) is shown isolated from control panel interface 1000. Exemplary button 1100 can be assigned to one or more commands stored on or otherwise accessible by controller 218.

Button 1100 can be selected (e.g., by a right-clicking action of a pointing device, by a touching action on a touch screen, etc.) and button window 1102 can be provided in response for accepting one or more commands for assignment to button 1100. A human operator can also be provided with a device log window, such as exemplary device log window 600 of FIG. 6, for selecting commands to be assigned to button 1100.

A human operator can select and place (e.g., by drag-and-drop action with a pointing device, by touching actions on a touch screen, etc.) one or more commands into button window 1102. For example, command/entry 614 can be selected and placed into button window 1102. Command 614 for changing the state of a lighting fixture associated with electrical switch device 214 of food preparation area 204 can be controlled through a human operator selecting button 1100 on control pad interface 1000.

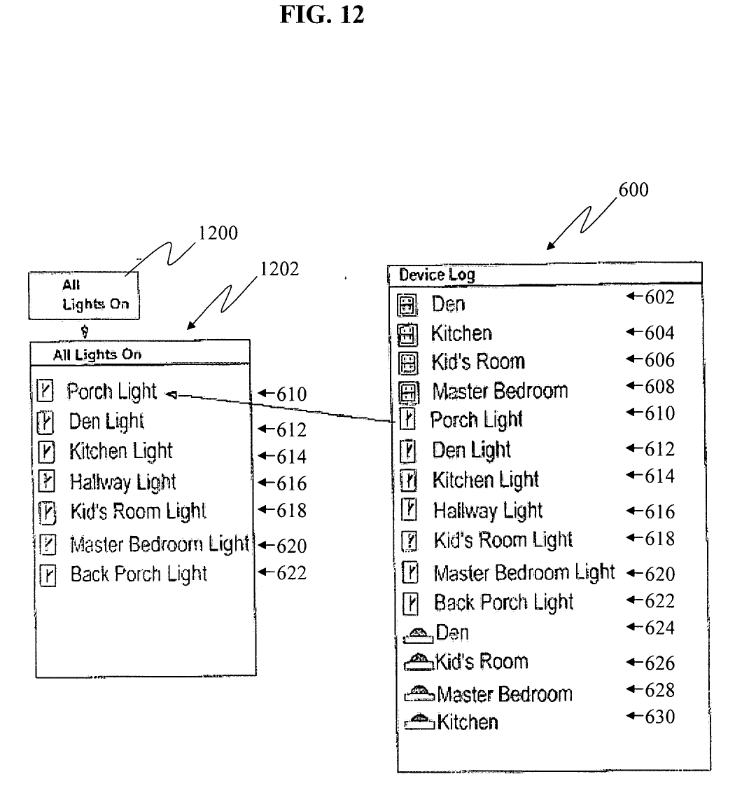

Similarly, referring to FIG. 12, button 1200 (labeled “All Lights On”) in isolation from a control panel interface. Exemplary button 1200 can be assigned to one or more commands stored on or otherwise accessible by controller 218.

Button 1200 can be selected (e.g., by a right-clicking action of a pointing device, by a touching action on a touch screen, etc.) and button window 1202 can be provided in response. Button window 1202 can accept one or more commands for assignment to button 1200. A human operator can also be provided with a device log window, such as exemplary device log window 600 of FIG. 6 for selecting commands to be assigned to button 1200.

A human operator can select and place (e.g., by drag-and-drop actions with a pointing device, by touching actions on a touch screen, etc.) one or more commands into button window 1202. For example, commands 610-622 can be selected and placed into button window 1202. Commands 610-622 can function together to change the state (e.g., to “on”) of lighting fixtures associated with electrical switch devices 214 through the selection of button 1200 on a control panel interface on controller 218. Button 1200 can be considered a macro-command button.

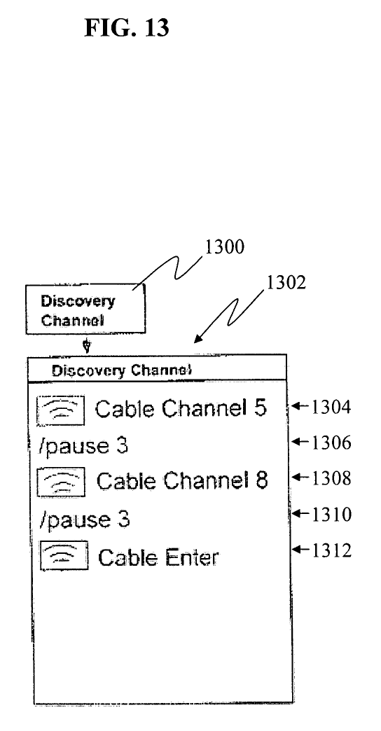

Referring to FIG. 13, another exemplary macro-command button is shown isolated from a control panel interface. Button 1300 can be selected to provide button window 1302. Command 1304, delay function 1306, command 1308, delay function 1310 and command 1312 can be selected, placed and logically ordered within button window 1302. Commands 1304, 1308, 1312 can be provided from one or more control station log windows. Functions, such as three-second pause functions 1306, 1310 and the like known to one having ordinary skill in the art, can be provided to a human operator through windows, toolbars, menus and any combination thereof, and like aspects of GUIs known to one having ordinary skill in the art.

As shown, button 1300 can define a macro-command to cable box 232 to effectuate a channel change to channel “58”. Commands 1304, 1308, 1312 and functions 1306, 1310 as ordered in button window 1302 provide command logic ordering selection of channel digit 5, three-second pause, selection of channel digit 8, three-second pause and enter. Channel “58” of a cable plan can correspond to a particular television network channel, such as THE DISCOVERY CHANNEL®, and button 1300 can be labeled by a human operator to intuitively refer to such.

Referring to FIG. 14, an exemplary macro-command window is shown that can be an aspect of a control panel interface of controller 218. Exemplary macro-command window 1400 can have a tab 1402. An automatic macro-command can be defined by a human operator in command window 1400 and thereafter controller 218 can independently (without human intervention) effectuate the defined series of logically-ordered commands. Defining an automatic macro-command can be commands, functions and selectable widgets (e.g., radio buttons) that can be provided to a human operator through windows, toolbars, menus and any combination thereof, and like aspects of GUIs known to one having ordinary skill in the art.

As shown, tab 1402 of macro-command window 1400 can include clock function 1404, electronic switch device command 1406, electronic outlet device command 1408, clock function 1410, electronic switch device command 1412, legacy device command 1414, legacy device command 1416, delay function 1418, legacy device command 1420, delay function 1422 and legacy device command 1424. Radio buttons 1426 can be provided to provide conditions and any other known functionality to the macro-command.

In response, controller 218 can carry out the logic of the macro-command to, for example, state-change (e.g., turn “on”) a lighting fixture associated with electrical switch device 214 of second bedroom 208 at 6:00, state-change (e.g., turn “on”) a socket of electrical outlet device 212 associated with coffee make 224 of food preparation area 204 at 6:00, state-change (e.g., turn “on”) a lighting fixture associated with electrical switch device 214 of food preparation area 204 at 6:20, state-change (e.g., turn “on”) and change the channel (to channel “67”) of television 226 via control station 216 of food preparation area 204 starting at 6:20. Also as shown, controller 218 can be limited to performing the macro-command to Monday through Friday of a calendar week by the conditions selected through selecting certain radio buttons 1426.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for controlling a plurality of devices, comprising:
a controller connected to a wireless network, the controller having a control panel interface;
one or more control stations connected to the wireless network, each of the control stations for converting a plurality of instructional commands to a plurality of device-specific control commands;
one or more legacy devices associated with each of the control stations, each of the legacy devices responsive to one or more of the plurality of device-specific control commands;
one or more electrical outlet devices connected to the wireless network, each of the electrical outlet devices responsive to one or more state-changing commands; and
one or more electrical switch devices connected to the wireless network, each of the electrical switch devices responsive to one or more state-changing commands.

2. The system of claim 1 wherein the wireless network is a wireless local area network (“WLAN”).

3. The system of claim 1 wherein the controller is one of a desktop computer, a laptop computer, a tablet computer, a personal digital assistant, a mobile phone, a portable media player and any combination thereof.

4. The system of claim 1 wherein the controller is one of a hand-held unit, a tabletop unit and a wall-mounted unit.

5. The system of claim 1 wherein an instructional command is embodied in radio data signal when transmitted.

6. The system of claim 1 wherein a device-specific command is embodied in infrared data signal when transmitted.

7. The system of claim 1 wherein a state-changing data commands is embodied in radio data signal when transmitted.

8. The system of claim 1 wherein the controller, the one or more control stations, the one or more legacy devices, the one or more electrical outlet devices and the one or more electrical switch devices are located in a private residence.

9. The system of claim 1 wherein the one or more legacy devices are infrared remote-controlled electronic devices.

10. A method of controlling a plurality of devices in an environment, comprising:
providing a control panel interface on a controller;
processing a command inputted via the control panel interface;
transmitting a first data signal embodying the command over a wireless network;
receiving the command at one of a control station, an electrical outlet device and an electrical switch device; and
processing the command at one of the control station, the electrical outlet device and the electrical switch device.

11. The method of claim 10 wherein the command is received and processed at the control station, further comprising:
transmitting a second data signal embodying a device-specific command; and
effectuating an operation of a legacy device.

12. The method of claim 10 wherein the command is received and processed at one of the electrical outlet device and the electrical switch device, further comprising:
effectuating a state-change at one of the electrical outlet device and the electrical switch device, respectively.

13. The method of claim 10 wherein the control panel interface is customizable through human operation.

14. The method of claim 10 wherein providing the control panel interface on the controller includes providing the control panel interface on a touch screen display of the controller.

15. The method of claim 10 wherein the command is one of an instructional command for a control station, a state-changing command for the electrical outlet device and a state-changing command for the electrical switch device.

16. The method of claim 10 wherein the first data signal is a radio signal.

17. The method of claim 11 wherein the second data signal is an infrared signal.

18. The method of claim 10 wherein the control station is associated with at least one legacy device.

19. A computer program product for controlling a plurality of devices in an environment, comprising:
a computer storage medium; and
a computer program code mechanism embedded in the computer storage medium for causing a computer to manage a plurality of devices, the computer program code mechanism comprising:
a first computer code device configured to provide a control panel interface, the control panel interface having a plurality of buttons assigned to a plurality of device commands;
a second computer code device configured to accept a selection from the plurality of buttons;
a third computer code device configured to match the selection to an assigned device command; and
a fourth computer code device configured to effectuate transmittal of the command to a device via a network, wherein the command is to be transmitted by a radio data signal.

20. The computer program product of claim 19 wherein the control panel interface is customizable through human operation.
